(19) United States
(12) Patent Application Publication
(10) Pub. No.: US 2012/0017505 A1
(43) Pub. Date: Jan. 26, 2012

(54) Container for Cultivating Agricultural or Biological Material

(76) Inventor: Jacob Johannes Bijl, Burgh-Haamstede (NL)

(21) Appl. No.: 13/143,710

(22) PCT Filed: Nov. 5, 2009
(86) PCT No.: PCT/NL2009/050666

§ 371 Date: Oct. 3, 2011

(30) Foreign Application Priority Data
Jan. 14, 2009 (NL) 1036422

(51) Int. Cl. A01G 9/02; B65D 51/00

(52) U.S. Cl. 47/66.7; 220/200

(57) ABSTRACT

The invention relates to a container (1) for at least cultivating for instance an agricultural or a biological material, the container comprising: a space (7) defined therein for in use accommodating at least the material arranged in the space,—at least one opening providing access to the space; and a closing means (5,9) associated in use with the opening to selectively inhibit access to the space, whereby the closing means exhibit a different permeability during and after initial cultivation.

The present invention relates to a container and method for at least cultivating for instance an agricultural or a biological material, where the container comprises a space defined therein for in use accommodating at least the material arranged in the space; at least one opening providing access to the space; and a closing means associated in use with the opening to selectively inhibit access to the space.

Such a container is known in the prior art, for instance from WO-A-2005/120.212 in the name of the present applicant.

Therein, a semi-permeable closing element, in particular a foil, is employed to inhibit access to the space. The foil ensures that the gas composition in and of the inner space of the container has the desired composition and humidity. The foil further ensures that the sowing material does not become contaminated with undesired micro-organisms, and also restricts access to the inner space of the container by organisms, such as insects. However, in particular in the early stages of growing biological or agricultural material, seeds or other sowing materials are particularly susceptible to environmental influences or contamination. The foil-like closing element has proven to restrict access to the inner space inadequately.

The present invention has been developed as an inventive addition to the prior art, in order to overcome or at least decrease the above-mentioned problems.

For achieving this goal, the present invention prescribes the additional feature that the closing means exhibit a different permeability during and after initial cultivation. Thus it is possible to adjust the permeability of the closing means dependent on the stage of growth, in particular cultivation or later, of the material. In particular, during the initial stages of growing agricultural or biological material, the closing means can exhibit a very low degree of permeability, to be effectively impermeable, to most effectively and maximally protect the young products during cultivation from environmental influences and contaminations, in particular as a consequence of an invasion of organisms, like insects, micro-organisms and the like, and to allow for regulation of the humidity.

In a particular embodiment a container according to the present invention can comprise a lemonade of at least two closing elements, of which the elements have a different permeability relative to one another and are arranged over each another. In particular in a configuration where the more impermeable closing means are arranged over the more permeable closing means, after completing the initial stage of cultivation, the more impermeable closing means can be removed, without affecting the placement of the more permeable closing means there underneath. Thus, after the initial stages of cultivation, invasion or exchange of air and water with the exterior of the container and evaporation of fluids from within the container can be allowed, for which purpose the more impermeable layer or closing means can be removed, leaving the more permeable layer or closing element in place. For instance, the lower most closing element can be heat sealed to the rim of the opening, while the outer most closing element can be an adhesive layer or foil or tape, arranged over the semi-permeable or more permeable layer or element there underneath. The element can be a plate like element or a foil itself, like the adhesive layer or foil there over. Also, the outer most closing element can be in the form of an plate like element, to most effectively close all access to the inner space of the container, while the lower most closing element could be a foil with perforations or other properties to exhibit a desired degree of permeability.

As noted before, the present invention also relates to a method for cultivating for instance an agricultural or biological material, or at least the present method according to the invention could also entail later stages than cultivation, which is an initial stage of growing, at least for the purpose of the present description of the invention. According to the invention the method comprises arranging the material in a space in a container, where the space is provided for in use accommodating at least the material, and where the container has at least one opening, providing access to the space. Further, the method comprises the step of closing the opening in use of the container to selectively inhibit access to the space. Additionally the step is employed of closing the opening during cultivation with a closing element having permeability and after initial cultivation, arranging on or over the opening a closing element having a different (higher or lower) permeability. It is noted, that this method is completely in conformity with the container. Further, as would appear from this indication of the invention, one could provide an embodiment of this method with a single closing element, rather than two distinct closing elements over or on top of each other. For instance, the method could comprise the step of processing or machining the closing element, which is arranged on the opening during initial cultivation steps, to after processing or machining exhibit a higher degree of permeability. For instances, a tape or foil could be adhered to the opening or the rim thereof, for instance on the basis of adhesion or a heat seal, and when the plant material or biological or agricultural material reaches a stage, where it is less susceptible to outside influences or contamination, the processing or machining of the pre-arranged closing element is performed to allow passage or permeation of at least water and air, for instance possibly also augmented with nutrients, into the space defined in the interior of the container.

As a consequence, also the use of a container according to the present invention in cultivation of agricultural or biological material is a proper aspect of the present invention.

The invention will now be described further using the following drawings and examples. These figures and examples serve only by way of illustration of the invention and are in no way intended to limit the scope of the invention, and therein similar or the same reference numbers are employed for the same or similar elements, components and aspects of the invention. In the drawings:

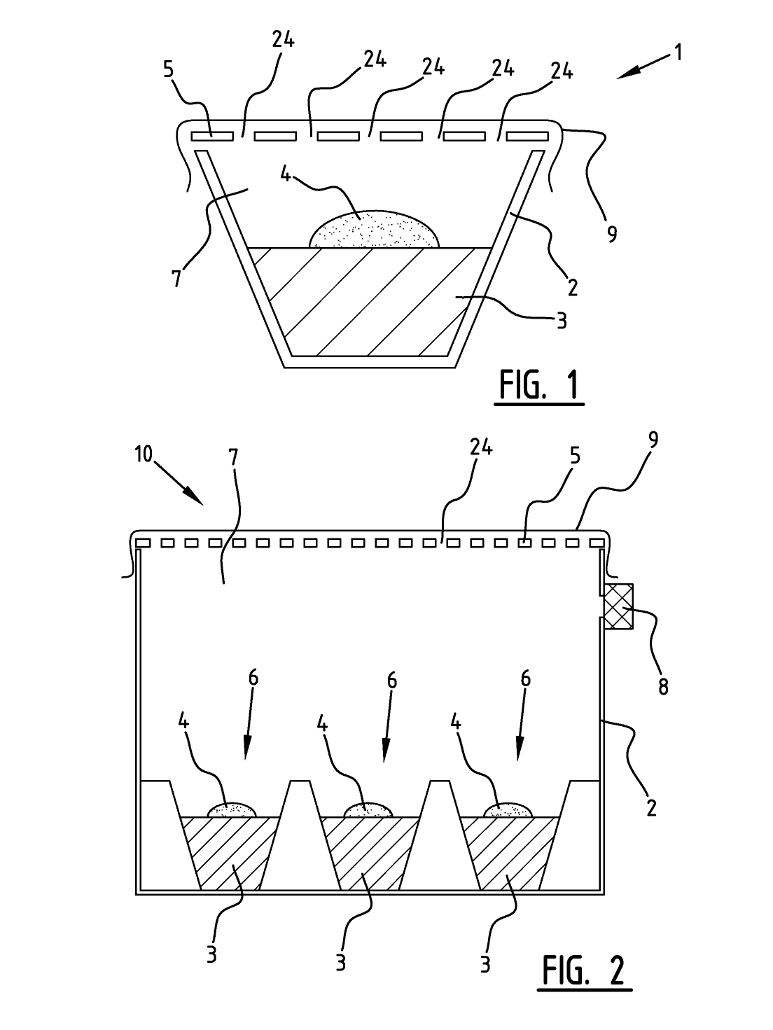

FIG. 1 shows a schematic side view in cross section of a container according to the invention;

FIG. 2 shows a schematic side view in cross section of a container according to the invention provided with a plurality of sub-containers;

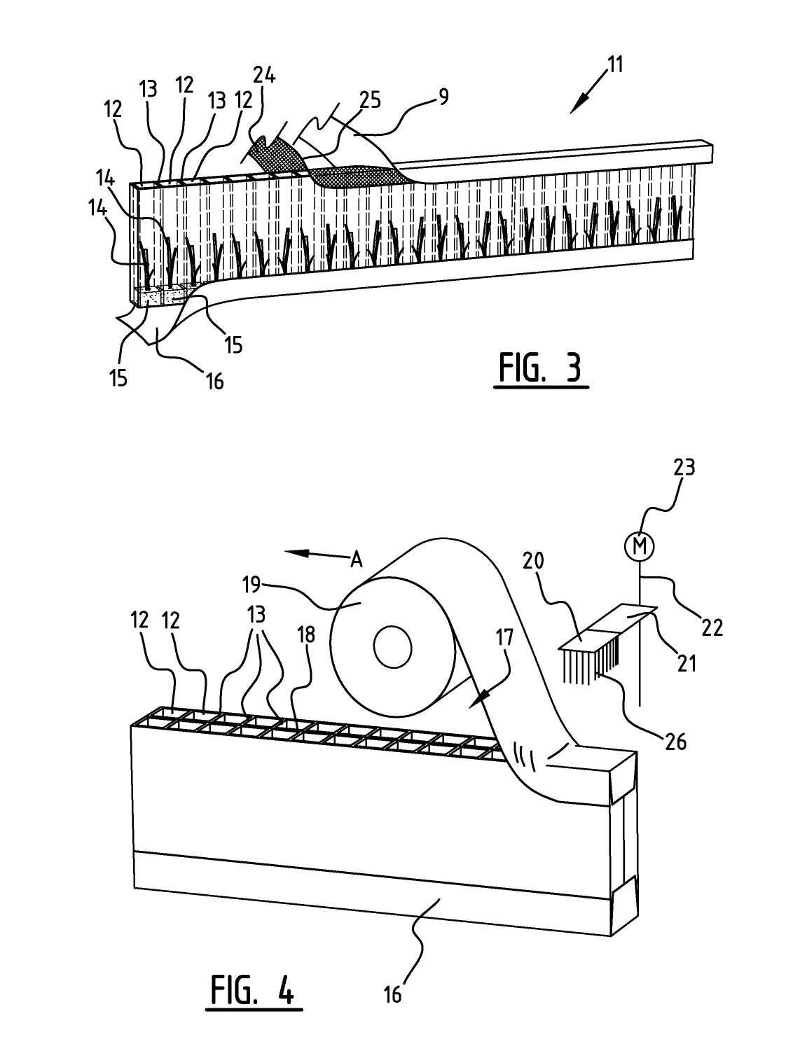

FIG. 3 shows another embodiment of the invention; and

FIG. 4 shows yet another embodiment of the invention.

FIG. 1 shows a side view of a container 1 according to the invention. Within the walls 2 of container 1 is placed an inert solid substrate 3, which is provided with growth medium. A quantity of sowing material, like seeds, in carrier material 4 is arranged on the top side of substrate 3. When the sowing material begins to develop, carrier material 4 is used up and the material continues to grow in substrate 3. Substrate 3 can then be separated from the container, in particular: taken out of the container, and be transferred into a pot with potting soil or similar substrate. The container 1 is open at the top thereof. On the thus formed opening is arranged a plate-like element 5 comprising perforations 24, preferably micro-perforations, to resist entry into the space of the container 1 with the sowing material on the substrate and/or in the carrier of harmful contamination, like insects, bacteria or other intrusions, which are in particular harmful during the initial stages of the growing of the material, which stage is referred to here as cultivation. Also the micro-perforations are used to regulate humidity in the inner space of the container.

Over the plate-like micro-perforated element 5 an adhesive foil 9 is arranged, which is essentially less permeable or impermeable in contrast with the plate-like micro-perforated plate, which plate can and does allow air and/or water (possibly with nutrients) to pass into the space of the container 1 for the benefit of the growth of the material after initial cultivation, as well as evaporation of fluids from within the interior of the inner space of the container. The adhesive foil 9 is arranged on the plate-like micro-perforated element 5, thus closing the micro-perforations 24, at least during initial cultivation. After completion of the stage of the initial cultivation, the adhesive foil 9 is removed, thus exposing the micro-perforations 24 in the plate-like element 5 to allow passage of for instance water and/or air and evaporation, but still hindering movement of contaminations into the space 7 of the container 1 as much as possible.

Likewise, in accordance with the basic concept of the present invention, especially within the method related aspects thereof, a more impermeable closing element can be arranged on or over the opening after both the initial and subsequent cultivation stages have been complete, e.g. to avoid de-hydration of the product in the container in storage or during transport, and irrespective of whether or not a more impermeable closing element is also provided during the initial stages of cultivation.

FIG. 2 shows a side view in cross section of a container 1 in an embodiment according to the invention. Container 1 is provided with a plurality, here three, of sub-containers 6 placed in container 1. An preferably inert substrate 3 is arranged in each sub-container 6. A carrier preparation 4 with sowing material therein is arranged on substrate 3. Container 1 is closed along side walls 2 by means of transparent plastic material. The top side of container 1 is closed using a semi-permeable plate-like element or foil 5. This element 5 ensures that the gas composition of inner space 7 of container 1 has the desired composition and humidity. Foil 5 further ensures that the sowing material does not become contaminated with undesired micro-organisms, after removal of the essentially less permeable or even impermeable foil 9. To enable the gas composition of inner space 7 of container 1 to be changed a valve 8 is placed against one of the walls 2 of container 1. Additional growth medium can however also be added to substrate 3 of sub-containers 6 through this valve 8.

FIG. 3 shows a perspective view of another embodiment of the present invention, comprising a container 11 having a number of compartments 12, which are mutually separated from each other by walls 13. The compartments are completely autonomous, and plant material 14 is arranged therein, having developing roots in a substrate 15. Further, the bottom of the compartments 12 is closed with an adhesive tape 16.

On top of the container 11, comprising the multiple compartments 12, a first tape 25 having perforations 24 therein, is arranged. The tape 25 having perforations 24 therein is attached to the tops of the compartments 12 or over the top of the container 11 to close the upper opening of the compartments 12 and thus to inhibit access to the plant material 14. The tape 25 is for instance arranged on top of the container 11 by means of a heat seal, which is also preferably attached to the upper edge of the walls 13. Alternatively, the tape 25 could also be an adhesive tape. Over the tape 25 having the perforations to allow a limited exchange of moisture and air there through as a consequence of the presence of the perforations 24, a less permeable or even impermeable tape 9, for instance an adhesive tape, is arranged. During cultivation, the tapes 25 and 9 are arranged on top of each other, and after the most crucial period of cultivation, the initial period has passed, the adhesive tape 9, which is essentially less permeable or even impermeable, is removed. Then, only tape 25 having perforations 24 remains, still inhibiting access to the interior space of the compartments 12, to a desired extent, especially with respect to contamination and micro-organisms, organisms like insects, and humidity control or regulation. The perforations are dimensioned for this purpose, for instance the perforations 24 are arranged with the aid of a laser or any other sufficiently accurate means to provide very small perforations, if required.

FIG. 4 shows another embodiment of the present inventions, were two rows of compartments 12 with intermediate walls 13 there between are provided in a container 17.

There is also a longitudinal divisional wall 18, to separate the two rows of compartments 12. The container 17 is, at the top thereof, covered by a closing element formed by an adhesive tape 19, which is initially impermeable. The tape 19 remains on top of the container 17 at least for the duration of the initial cultivation stage, in which agricultural or biological material is most susceptible to contamination and micro-organisms. After the initial stages of vulnerability of the biological or agricultural material, the adhesive tape 19 on top of the container 17 and closing the upper sides of the compartments 12, is perforated using mechanical means, such as for instance a carrier plate 20, carrying needles 26, which is/are repeatedly moved up and down, while the container 17 is past underneath the needles 26. Any other convenient means for perforating the adhesive tape 19 could also be employed. The carrier plate 20 is connected via a connecting plate 21 to a guide 22, which is connected to a motor 23, to provide an up and down movement of the needles 26 to and from the adhesive tape 19, in order to provide the perforations, after the initial stages of cultivation, in which the biological or agricultural material is most funderable and susceptible to contamination and micro-organisms has passed.

It will be abundantly clear to any skilled person, that after the above disclosure of the present invention, many alterations, additions and alternative embodiments are within reach, which have all not been excluded from the scope of protection for the present invention as defined in letter or in spirit in the accompanying claims. For instance, the mechanical means comprising needles for arranging perforations in an adhesive tape can be replaced, for instance by a laser, in as far as that laser could be sufficiently accurate and could be used without causing harm or damage to the biological or agricultural material inside the container. Any other means for providing an increased degree of permeability could also be employed. In as far is necessary it is noted here, that the expression permeability relates especially to air moisture and gasses, which are not able to pass through a closing element, if that is considered to be impermeable. The expression semi-permeable is applied in the same manner, i.e. penetrable by water, gas, air and moisture for humidity regulation, but preferably not by organisms like insects, micro-organisms or other contamination.

1. Container for at least cultivating for instance an agricultural or a biological material, the container comprising: a space defined therein for in use accommodating at least the material arranged in the space; at least one opening providing access to the space; and a closing means associated in use with the opening to selectively inhibit access to the space, characterized in that the closing means exhibit a different permeability during and after initial cultivation, wherein the closing means comprise a laminate of at least two closing elements, of which the elements have a different permeability relative to one another and are arranged over each other.

2. Container according to claim 1, wherein the closing means has a higher permeability after cultivation than before.

3. Container according to claim 2, wherein the outermost of the closing elements relative to the space exhibits a lesser degree of permeability than the innermost closing element relative to the space.

4. Container according to claim 3, wherein the innermost closing element comprises perforations.

5. Container according to claim 3, wherein the outermost closing element is essentially less permeable or even impermeable.

6. Container according to claim 1, wherein the innermost and outermost closing elements comprise independently releasable attaching means.

7. Container according to claim 6, wherein the attaching means of at least one of the innermost and the outermost closing elements comprises a heat seal.

8. Container according to claim 6, wherein the attaching means of at least one of the innermost and the outermost closing elements comprises bonding means, selected from the group of a sticking means, a bonding means, an adherence means, or the like.

9. Container according to claim 8, wherein the at least one of the innermost and the outermost closing elements comprises a sticky tape.

10. Method for at least cultivating for instance an agricultural or a biological material, the method comprising: arranging the material in a space defined in a container, said space being provided for in use accommodating at least the material and the container having at least one opening providing access to the space; and closing the opening in use of the container to selectively inhibit access to the space, characterized by closing the opening during cultivation with a closing element and after initial cultivation closing the opening with a closing element having a different permeability, wherein the closing means comprise a laminate of at least two closing elements, of which the elements have a different permeability relative to one another and are arranged over each other.

11. Method for at least cultivating for instance an agricultural or a biological material, the method comprising: arranging the material in a space defined in a container, said space being provided for in use accommodating at least the material and the container having at least one opening providing access to the space; and closing the opening in use of the container to selectively inhibit access to the space, characterized by closing the opening during cultivation with a closing element and after initial cultivation closing the opening with a closing element having a different permeability, wherein the closing element arranged on the opening is after initial cultivation processed to increase the permeability thereof and left on the opening after initial cultivation to provide after initial cultivation the higher permeability.

12. Method according to claim 10, wherein a closing element having a low permeability is arranged for closing the opening after the initial and subsequent cultivation are completed, e.g. for transport of the container.

13. Use of a container according to claim 1 in the cultivation of agricultural or biological material.
